(19) United States
(12) Patent Application Publication
(10) Pub. No.: US 2014/0337100 A1
(43) Pub. Date: Nov. 13, 2014

(54) SYSTEM AND METHOD OF OBTAINING CUSTOMER FEEDBACK

(71) Applicants: Mark Crawford, Ankeny, IA (US); Caleb Roney, Des Moines, IA (US); Joseph K Roney, III, Des Moines, IA (US)

(72) Inventors: Mark Crawford, Ankeny, IA (US); Caleb Roney, Des Moines, IA (US); Joseph K Roney, III, Des Moines, IA (US)

(21) Appl. No.: 14/275,254

(22) Filed: May 12, 2014

Related U.S. Application Data
(60) Provisional application No. 61/822,000, filed on May 10, 2013.

(51) Int. Cl. G06Q 30/02

(52) U.S. Cl. CPC G06Q 30/0201
USPC 705/7.32

(57) ABSTRACT

A system and method of obtaining customer feedback uses an application that directs a survey instrument to be received by a customer's own phone or network enabled device. The service provider performs a service or provides a sale and asks the customer to participate in a survey. To increase the likelihood that the customer will participate, the service provider explains that the survey will be sent to the customer's phone. The service provider places a call to initiate an automated survey which is directed to the customer's phone. The data collected is stored and retrievable through a cloud based administrative portal where the service provider client is able to utilize the data collected. In one embodiment, the process is automated and is initiated when the service provider calls or signs in and enters the customer information in an application which sends the survey instrument to the customer.

### CROSS REFERENCE TO RELATED APPLICATIONS

This application claims priority and herein incorporates by reference U.S. provisional patent application 61/822,000, filed May 10, 2013.

### BACKGROUND OF THE INVENTION

In the information age, it is easier than ever to collect data from and about customers to better serve the needs of the customer. Of course raw data is not necessarily usable and asking consumers to give feedback can be problematic both in making the consumer feel uncomfortable and actually provoke negative feelings about the product or service for which feedback is being solicited. It is well known to ask a customer to fill out a survey regarding their experience with a product or service.

With the exploding use of cellular communication and other network enabled devices, it is known to ask a customer to take a survey using the feedback initiator's device. This can lead to increased customer hesitancy to provide the information requested due to unfamiliarity with the device and sanitary concerns. There is a need for a system to encourage customers to provide feedback when requested by a provider that overcomes the limitations of the prior art.

### SUMMARY OF THE INVENTION

A system and method of obtaining customer feedback uses an application that directs a survey instrument to be received by a customer's own phone or network enabled device. The service provider performs a service or provides a sale and asks the customer to participate in a survey. To increase the likelihood that the customer will participate, the service provider explains that the survey will be sent to the customer's phone. The service provider places a call to initiate an automated survey which is directed to the customer's phone. The data collected is stored and retrievable through a cloud based administrative portal where the service provider client is able to utilize the data collected. In one embodiment, the process is automated and is initiated when the service provider calls or signs in and enters the customer information in an application which sends the survey instrument to the customer.

Other features and advantages of the instant invention will become apparent from the following description of the invention which refers to the accompanying drawings.

### BRIEF DESCRIPTION OF THE DRAWINGS

FIG. 1 is system diagram of a system and method of obtaining customer feedback according to an embodiment of the invention.

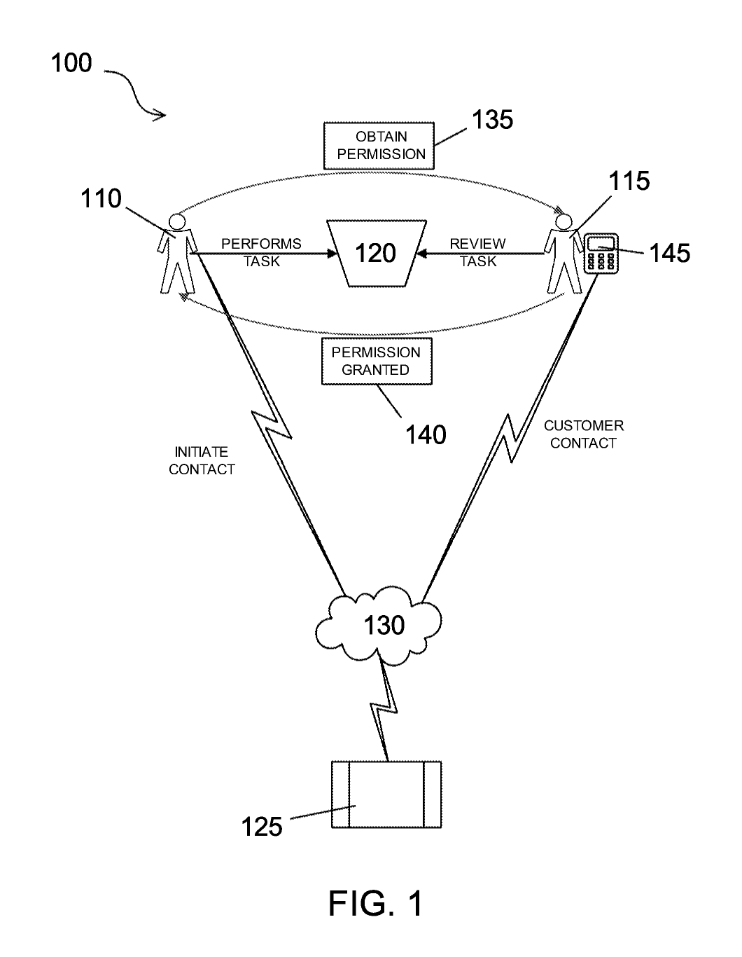

FIG. 2 is a flow diagram of the process of obtaining customer feedback according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

Referring to the figures, a system and method of obtaining customer feedback 100 is shown with a service provider 110 performing a service 120 to a customer 115. The service 120 can be a professional service, such as medical care, legal, accounting or other service or it can be physical labor like rug cleaning, car mechanic, roofing contractor, etc. After performing the service 120, service provider 110 asks customer 115 if they would be willing to take a survey regarding the service 120 they received. To encourage participation, the customer 115 is told that if they give their permission, the survey will be delivered to them by receiving a call on their personal communication device 145 such as a telephone, cell phone, smart phone, communications enabled tablet or any suitable communication device. Because the customer 115 is allowed to use their own device 145, they are put at ease and are more likely to agree to the survey. Many people are uncomfortable using the service provider's device because they are unfamiliar with its operation and because communication devices are usually held close to the mouth and they may feel uncomfortable using a stranger's device.

If the customer 115 gives their permission 135, service provider 110 initiates a communication using a device and places a phone call or a text to a network enabled application 130. Network enabled application 130 is a software application that accepts the service provider's input and directs a call to be placed to the customer 115 using the customer's device 145 once permission is granted 140. The customer's responses are recorded in a database application 125. Of course other methods of providing the survey or other feedback instrument may be used such as, but not limited to, live operator, computer program or recorded messages, etc.

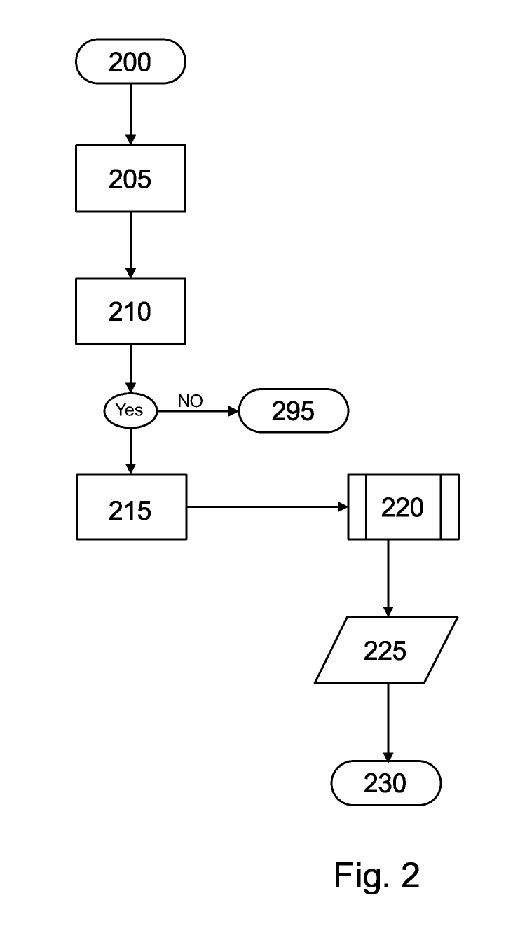

Referring to FIG. 2, a flow chart illustrates a basic format for the system of obtaining feedback from a customer and is shown starting 200 with the service provider initiating customer contact and performing a service 205. Once service 205 is performed to the customer's satisfaction, the service provider asks permission 210 for the customer to receive a survey using the customer's own device. If the customer declines, the system ends 295. Of course, it may be advantageous to prepare an alternate means of obtaining customer feedback if the customer declines to be contacted. Alternative means may include, but not limited to, providing the customer with a telephone number to call, a website to visit, a mailing card, etc. Additionally, if the customer declines, it may be desirable to ask the customer why they are refusing.

If the customer accepts, the service provider places a call using his or her telephone or network enabled device to initiate contact with a survey application 215 which allows the service provider to provide a communication means such as a phone number to permit survey application 215 to initiate a call to customer 220 using the customer's own device. The service provider dials a number that connects the service provider to the survey application 215. Alternatively, the service provider may sign in to a website to provide the necessary customer contact information. Other contact means may be used to initiate and enter the required customer's information such as texting, voice recording, scanning a QR code or other electronic coding system, etc. The customer's device can include wired telephone, cell phone, network enabled device or other suitable communication device. The information is recorded in a data collection database application 225 for further analysis. Once the customer receives the call and responds, the system ends 230.

Although the above has been described in respect to a service performed by a service provider, it should be clear that the above is applicable to an embodiment where the customer has made a purchase in either a brick and mortar store or a virtual store such as a website or smart phone application. Once the customer has given their permission to receive the feedback instrument, the system operates in the same manner as described above.

Further, in regard to the survey instrument, it is an automated application that launches an automated phone survey that is defined by the service provider. It may be customized to solicit particular information desired or it may be selected as a generic information gathering instrument depending on the application desired. Service providers utilize a secure administrative portal where they view the results, choose options, pay for the service, etc. as is known in the art. In addition to the automated embodiment, other methods of delivering the survey instrument are acceptable such as, but not limited to, live operators, downloadable application for a smart phone or tablet or other suitable information gathering device.

In regard to the step of initiating the survey which is performed by the service provider once permission has been granted, the service provider signs in to an application on a network enabled device such as a smart phone or tablet, and enters the customer contact information thereby initiating the system to contact the customer on his or her device.

In another embodiment, the customer implicitly gives permission to receive the survey instrument by virtue of them purchasing the service or good and the system automatically launches the steps required to deliver the survey instrument to the customer on his or her device. Data storage of the information gathered by the survey is stored on a digital storage device that is cloud based so that clients and/or customers can access to the appropriate information regardless of location. Of course other storage systems may be used such as, but not limited to, dedicated servers at a physical location, off-site storage facility etc. where data is stored and retrieved as is known in the art.

Although the instant invention has been described in relation to particular embodiments thereof, many other variations and modifications and other uses will become apparent to those skilled in the art.

What is claimed is:

1. A method of obtaining customer feedback using a communication device, comprising:
obtaining a portable communication device capable of receiving and transmitting information across a communication network for use by a service provider;
performing a service for a customer by said service provider;
contacting a survey application using said communication network;
entering customer information for storage in said survey application;
storing said customer information in a memory storage device which is a part of said survey application; and
initiating contact with said customer utilizing a customer's communication device, wherein said customer's communication device's contact information is retrieved from said memory storage device wherein customer feedback is obtained.

2. The method of obtaining feedback using a communication device according to claim 1 wherein said contacting a survey application is performed by dialing a selected telephone number.

3. The method of obtaining feedback using a communication device according to claim 1 wherein said initiating contact with said customer is performed by logging on a website.

4. The method of obtaining feedback using a communication device according to claim 1 wherein said survey application is a software app running on a communication enabled computer connected to a communications network.

5. The method of obtaining feedback using a communication device according to claim 1 wherein said initiating contact with said customer is performed by said survey application dialing a customer's telephone number.

6. The method of obtaining feedback using a communication device according to claim 1 wherein said initiating contact with said customer is performed by said survey application by sending a text to said customer's communication device.

7. The method of obtaining feedback using a communication device according to claim 1 wherein said initiating contact with said customer is performed by said survey application by sending an email.

8. The method of obtaining feedback using a communication device according to claim 1 further comprising logging said service provider in to an administrative portal wherein said service provider can access account options.

9. The method of obtaining feedback using a communication device according to claim 1 wherein feedback is obtained by means of a survey instrument.

10. The method of obtaining feedback using a communication device according to claim 1 where said survey application is a network enabled application.

11. The method of obtaining feedback using a communication device according to claim 1 wherein said survey application is a software app running on a communication enabled computer and includes a database for storing, organizing and retrieving said customer information.
